(19) United States
(12) Patent Application Publication
(10) Pub. No.: US 2003/0048343 A1
(43) Pub. Date: Mar. 13, 2003

(54) Process for preparing a laminated ink jet print

(76) Inventors: Brian L. Anderson, Westfield, MA (US); Jamil D. Hadla, Westfield, MA (US); Edward M. McCarron JR., South Hadley, MA (US); Wendi M. West, Chicopee, MA (US)

Correspondence Address: E. Joseph Gess, Esq., BURNS, DOANE, SWECKER & MATHIS, L.L.P., P.O. Box 1404, Alexandria, VA, 22313-1404, US

(21) Appl. No.: 09/941,562

(22) Filed: Aug. 30, 2001

(51) Int. Cl. B41J 2/01

(52) U.S. Cl. 347/101

(57) ABSTRACT

Provided is a process for preparing a laminated ink jet printed image. The process comprises first coating an ink jet image receiving layer onto a clear base material useful for lamination. An image is printed on the image receiving layer, and then the resulting construction is applied to a substrate with heat and pressure such that the image bearing layer is in between the substrate and the clear base and is protectively sealed by means of the clear base. The clear base layer acts as a protective layer for the image bearing layer.

### BACKGROUND OF THE INVENTION

1. Field of the Invention

The present invention relates to a laminated ink jet image, and more particularly, to a process for preparing such a laminated ink jet printed image in a cost effective and efficient manner.

2. Description of the Related Art

Ink jet printing is a printing technology in which color dots are formed on a substrate from ink droplets ejected from nozzles in a print head. The inks are generally composed of water, a water soluble dye or a pigmented dye, one or more water-miscible cosolvents, and one or more surfactants. The substrate of the ink jet medium can generally be one of many different materials, e.g., plain paper, coated paper, plastic film, cloth or plastic. In order to form a high resolution image, the substrate is usually coated with a specially formulated ink jet coating, which is the image receiving layer. There are many types of coatings known to the art, e.g., as described generally in U.S. Pat. No. 5,965,244. Many of such ink jet coatings, or image receiving layers, are comprised of film forming polymers which are generally hydrophilic. Such hydrophilic polymers are either water soluble or water swellable.

One of the major drawbacks of the ink jet printing process has always been the lack of long term durability of the images. Ink jet prints have always been prone to ultraviolet light fading, moisture sensitivity and scratch resistance.

Due to these problems, the great majority of wide format ink jet images are over laminated. The laminate material is comprised of a base sheet, usually a polyester such as a poly(ethylene terephthalate), or polyvinyl chloride film, and an adhesive. The over laminate is applied after imaging with a laminating device that uses heat and/or pressure to effect the lamination, protectively sealing the imaged layer. For some end uses, however, where a rigid sign is needed, a two sided pressure adhesive is applied to a signboard backing, then the over laminated, printed image construction, is adhered to the signboard. Such a structure, with all of its layers, is shown in FIG. 1 of the drawing. This entire process of preparing the wide format, signboard is time consuming, labor intensive and costly. A more cost effective process to prepare such a wide format product would be welcomed by the industry.

It is therefore an objective of the present invention to provide a more cost effective and efficient process for preparing a laminated ink jet printed image.

It is another object of the present invention to provide a novel process for preparing an ink jet printed sign where the image is protected by a laminated protective layer.

Still another object of the present invention is to provide a less costly and more simple laminated ink jet printed sign.

These and other objectives of the present invention will become apparent to the skilled artisan upon a reading of the specification, the claims appended thereto, and a review of the Figures of the drawing.

### SUMMARY OF THE INVENTION

In accordance with the foregoing objectives, there is provided a process for preparing a laminated ink jet printed image. The process comprises first coating an ink jet image receiving layer onto a clear base material useful for lamination upon application of heat and pressure to thereby protectively seal the ink jet image layer. An image is then printed on the image receiving layer to form an imaged layer. The imaged layer on the clear base is then applied to a substrate with heat and pressure such that the image bearing layer is in between the substrate and the clear base and is protectively sealed by means of the clear base, which clear base acts as a protective layer for the image bearing layer. The resulting product is a laminated ink jet printed image with a protective clear coating.

The present process has particular applicability to preparing signs, where the printed image needs a rigid backing, such as a signboard. The process of the present invention allows one to prepare a sign more quickly and cost effectively than with the prior art process of over-laminating. The final ink jet printed sign also avoids the need for a traditional ink jet substrate, e.g., such as a photobase substrate, and thereby yields a less costly and more simple structure.

### BRIEF DESCRIPTION OF THE FIGURES OF THE DRAWING

FIG. 1 of the Drawing depicts a prior art structure prepared by a typical prior art process of over lamination.

FIG. 2 depicts a structure in accordance with the present invention after an image has been printed, but before lamination and protective sealing.

FIG. 3 of the Drawing depicts a final structure in accordance with the present invention after lamination by application of heat and pressure.

### DETAILED DESCRIPTION OF PREFERRED EMBODIMENTS OF THE INVENTION

The process of the present invention allows one to prepare a protective ink jet printed image more quickly and efficiently. The process comprises first coating an ink jet image receiving layer onto a clear base material. This base material can be any suitable, clear, material which under heat and pressure can protectively seal the image receiving layer once the image has been printed thereon. For purposes of the present invention, the clear base material is referred to as a laminating material, which means that the material under heat and pressure will soften, and protectively seal the image receiving layer (once an image has been printed thereon) to protect the layer from moisture and scratches, as well as UV light fade should the protective layer also contain a suitable additive. The coating of the ink jet image receiving layer onto the clear base material can be by any conventional means for coating such layers.

Once the layer has been coated, an image is then printed on the image receiving layer to form an image layer. In accordance with the present invention, such printing is accomplished by ink jet printing. Conventional ink jet printers can be used for this process.

The image layer on the clear base is then applied to a substrate such that the image bearing layer is in between the substrate and the clear base. Heat and pressure is applied to thereby effect a lamination of the clear base material and hence protectively seal the image bearing layer. Conventional lamination equipment can be used to apply the heat and pressure. The clear base thereby acts as a protective layer for the image bearing layer. The resulting product is a laminated ink jet printed image with a protective clear coating.

The clear base, which later acts as a protective layer, can be any suitable material which can protectively seal the image bearing layer upon application of the heat and pressure. Preferably, the material can be, but is not limited to, the following:

Poly(ethylene terephthalate)

Poly(vinyl chloride)

Poly (carbonate)

The ink jet image receiving layer can be any suitable ink jet receiving layer as is known in the art, but is preferably a hydrophilic layer that rapidly absorbs aqueous inks. It also preferably acts as an adhesion-promoting layer. Therefore, in a preferred embodiment, the receiver layer will contain at least one hydrophilic resin and at least one adhesion promoting resin. The presence of the adhesion promoting resin would eliminate any need of using an adhesive layer to secure the image bearing layer to the substrate.

Examples of suitable hydrophilic resins for use in connection with the present invention include poly(vinyl pyrrolidone); vinyl pyrrolidone/diamino ethylmethacrylate copolymers; acrylamide polymers; poly (vinyl alcohol); hydroxyethyl cellulose; hydroxypropyl cellulose and carboxymethyl cellulose, or mixtures thereof.

Examples of suitable adhesion promoting resins for use in conjunction with the hydrophilic resins include polyurethanes, poly (vinyl acetate), acrylic copolymers and ethylene/vinyl acetate copolymers. Such adhesion promoting resins are optional, as described above, but are preferred.

The substrates that the resulting ink jet prints can be applied to can be any suitable substrate. The present invention has special application, however, to wide format ink jet images useful in making signs. In such a case, the substrate used is generally a rigid, stiff substrate such as a signboard or foam board. Substrates suitable for use in a wide format for preparing signs can include, but are not limited to, the following:

Expanded poly(vinyl chloride)

Clay coated foam board

Cardstocks

Poly(vinyl chloride) banner

Poly(ethylene terephthalate)

Poly(ethylene)

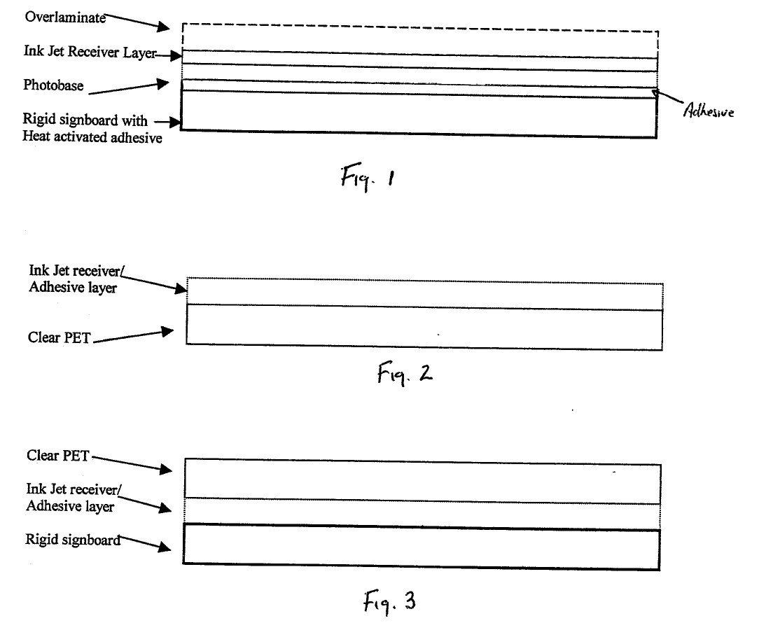

In preparing a rigid sign using the process of the present invention with the wide format ink jet image, the process of the present invention allows one to simplify the entire process and actually eliminate a layer which is generally the typical substrate of an ink jet print. The process of the present invention actually coats and prints on the clear base material, which later becomes the protective layer. Lamination or protective sealing of the image bearing layer by the clear base occurs after the image has been printed on the image receiving layer, but the lamination process also combines the application of the image bearing layer/clear base to the sign substrate, generally a rigid signboard or foam board as shown in FIG. 3. In FIG. 3, the top protective layer is the clear base, preferably polyethylene terephthalate. The middle layer is the ink jet receiver-image layer containing the image. Preferably, this layer also includes an adhesion promoting resin. The substrate is the rigid signboard. This simple structure is in contrast to the traditional prior art structure as shown in FIG. 1. From FIG. 1, it can be seen that the traditional substrate of a photobase for the ink jet print is part of the structure, as is the necessary adhesive layer to adhere the entire ink jet print to the rigid signboard. Those two layers are easily eliminated by the present process, making the overall structure more simple, and less costly.

Another process advantage of the present invention is that the prior art generally requires several runs to be made through the laminator. Excellent results are obtained, however, with only one lamination run when employing the present invention.

The present invention therefore provides a protective ink jet printed image which is more simple in construction and is prepared by a process which is more efficient and cost effective than the prior art process of over laminating the ink jet print. Particular application of the present invention is found with regard to wide format imaging where the printed images are to be applied to a rigid signboard to create a sign. In such a case, the present invention avoids the need for the presence of the traditional ink jet substrate, e.g., a photobase.

The present invention will be further illustrated by the following examples, which are meant to be merely illustrative and in no way limiting.

In the following examples, the various chemical components noted are more particularly described as follows:

| | |
|---|---|
| Airflex 110 | vinyl acetate/ethylene copolymer latex |
| | from Air Products and Chemicals, Inc. of |
| | Allentown, Pa. |
| Syloid 620 | amorphous silica from W. R. Grace, |
| | Baltimore, Md. |
| Ageloc A-50HV | poly(Hydroxyalkene Ammonium chloride) |
| | from C.P.S. Chemicals of Old Bridge N.J. |
| Zonyl FSN | Nonionic fluorosurfactant from DuPont |
| | of Wilmington, De. |
| Gafquat 755 N | Quaternized copolymer of vinyl |
| | pyrrolidone and dimethylaminoethyl |
| | methacrylate from International Specialty |
| | Products of Wayne, NJ |
| PVP K90 | Poly (vinyl pyrrolidone) from |
| | International Specialty Polymers of |
| | Wayne, NJ |

| | |
|---|---|
| Neorez R-9320 | Polyurethane adhesive from Neoresins |
| | of Waalwijk, Netherlands |
| Dispercoll U53 | Polyurethane adhesive from Bayer Group |
| | of Leverkusen, Germany |
| Cyanamer P-21 | Poly(acrylamide) from Cytec Industries |
| | Inc. of Stamford, ST. |
| Klucel G | Hydroxypropyl cellulose from Hercules |
| | Inc. of Wilmington, DE. |
| Zonyl FSJ | Anionic fluorosurfactant from DuPont |
| | of Wilmington, De. |
| Sintra | Expanded poly(vinyl chloride) sign |
| | board from Alcan Composites of Zurich, |
| | Switzerland. |
| Atic Premium Mount | Double sided pressure sensitive |
| | adhesive mounting film from GBC of |
| | Addison, Illinois |
| Rexcoat | Thermally activated laminate from |
| | Rexam Image Products of South Hadley, MA. |
| Orca III | Laminator from GBC of Addison, |
| | Illinois. |
| Rohadon MW 235 | Poly(methyl methacrylate) bead from |
| | Rohm America of Piscataway, N.J. |

### EXAMPLE 1

A composition of the following components was prepared:

| CHEMICAL | % BY WEIGHT |
|---|---|
| Deionized Water | 17.54 |
| Syloid 620 | .26 |
| Rohadon MW 235 | .53 |
| Zonyl FSN | .07 |
| 2% Klucel G | 23.37 |
| Airflex - 110 | 20.37 |
| Neorez R-9320 | 13.34 |
| PVP-K90 15% SOL | 4.38 |
| Gafquat 755 N | 8.77 |
| Dispercoll U53 | 1.90 |
| Cyanamer P-21 10% | 8.77 |
| TOTAL | 100.00 |

The above mix was prepared by adding the amorphous silica and Rohadon MW 235 beads to the deionized water, and stirring for 5 minutes with a Lightn'in mixer on high speed. The Klucel G solution was added slowly and mixed for 5 minutes. The Airflex 110, Neorez R-9320 and PVP K-90 solution were added and stirred for 10 minutes. The remaining ingredients were added under agitation and stirred for an additional 15 minutes.

The mixture was then coated onto a clear polyester terephthalate (PET) film with a 90 Mayer Rod and dried in a Blue M convection oven to achieve a dry coating weight of 7.0 lbs/MSF. See FIG. 2 of the Drawing for a resulting product construction diagram.

The sample was then printed on a Hewlett Packard 2500 ink jet printer with the dye ink set using a full color test pattern.

The printed sample was allowed to dry for one hour, then laminated onto a Sintra rigid signboard with an Ocra III laminator at 250° F., 90 pounds per square inch pressure, and a line speed of 3 feet per minute. The results can be seen in Table 1. The finished product construction diagram can be seen in FIG. 3 of the Drawing.

### EXAMPLE 2 - COMPARATIVE

| CHEMICAL | % BY WEIGHT |
|---|---|
| Water | 35.00 |
| Ethanol | 20.00 |
| Syloid 620 | 0.05 |
| PVP K90 | 5.00 |
| 88% hydrolyzed polyvinyl | 35.00 |
| alcohol solution | |
| Styrenated acrylic | 4.29 |
| solution | |
| Zonyl FSI | 0.66 |

The above mix was prepared by adding the Syloid 620 to the deionized water and ethanol, and then mixed for 1 minute with a Lightn'in mixer on high speed. The PVP K90 is added slowly under agitation, then stirred on high speed for 20 minutes until dissolved. The polyvinyl alcohol, styrenated acrylic and Zonyl FSJ were then added and mixed for an additional 15 minutes.

The mixture was then coated onto a 150 gram per square meter polyethylene clad photobase paper from Schoeller Technical Papers with a 70 Mayer Rod and dried in a Blue M convection oven to achieve a dry coating weight of 2.50 lbs/MSF.

The sample was then printed and measured in the same manner as Example 1.

To prepare a protected sign, the following steps were followed:

1. After printing, the sample was allowed to dry for one hour.

2. Arctic Premium Mount double-sided adhesive was applied to a Sintra rigid sign stock. The printed sample was then adhered to the Sintra with the adhesive.

3. The printed Sintra was over laminated with Rexcoat laminate and an Ocra 111 laminator set at 220° F., 95 pounds per square inch, and 3 feet per minute.

The final structure is illustrated in FIG. 1.

Therefore, it can be seen that the process of the prior art for preparing an over laminated ink jet print is complicated and very time consuming. The process of the present invention offers a more efficient and cost effective alternative which also provides one with a simpler structure.

While the invention has been described with preferred embodiments, it is to be understood that variations and modifications may be resorted to as will be apparent to those skilled in the art. Such variations and modifications are to be considered in the purview and the scope of the claims appended hereto.

What is claimed is:

1. A process for preparing a laminated ink jet printed image comprising the steps of:
(i) coating an ink jet image receiving layer onto one side of a clear base useful for lamination by heat and pressure;
(ii) printing an image on the image receiving layer to establish an image layer on the clear base;
(iii) applying the image layer/clear base onto a substrate with heat and pressure such that the image layer is in between the substrate and the clear base and protectively sealed by means of the clear base, which base acts as a protective layer for the image layer.

2. The process of claim 1, wherein the image receiving layer comprises a hydrophilic resin.

3. The process of claim 2, wherein the hydrophilic resin is selected from the group consisting of poly(vinyl pyrrolidone), acrylamide polymers, poly(vinyl alcohol), hydroxyethyl cellulose, hydroxypropyl cellulose and carboxymethyl cellulose.

4. The process of claim 2, wherein the image receiving layer is comprised of polyvinyl pyrrolidone.

5. The process of claim 2, wherein the image receiving layer further comprises an adhesion promoting resin.

6. The process of claim 5, wherein the adhesion promoting resin contained in the image receiving layer is selected from the group consisting of polyurethanes, poly(vinyl acetate), acrylic copolymers and ethylene/vinyl acetate copolymers.

7. The process of claim 1, wherein the substrate is a rigid signboard.

8. The process of claim 1, wherein the substrate is comprised of a rigid foamed material.

9. The process of claim 1, wherein the clear base useful for lamination is comprised of a material selected from the group consisting of poly(ethylene terephthalate), poly(vinyl chloride), and polycarbonate.

10. A laminated structure which comprises an ink jet printed image layer over a rigid substrate, and a clear, laminated protective layer over the image layer which acts as a protective layer for the image layer.

11. The structure of claim 10, wherein the image receiving layer comprises a hydrophilic resin.

12. The structure of claim 11, wherein the hydrophilic resin is selected from the group consisting of poly(vinyl pyrrolidone), acrylamide polymers, poly(vinyl alcohol), hydroxyethyl cellulose, hydroxypropyl cellulose and carboxymethyl cellulose.

13. The structure of claim 12, wherein the image receiving layer is comprised of polyvinyl pyrrolidone.

14. The structure of claim 11, wherein the image layer further comprises an adhesion promoting resin.

15. The structure of claim 14, wherein the adhesion promoting resin contained in the image layer is selected from the group consisting of polyurethanes, poly(vinyl acetate), acrylic copolymers and ethylene/vinyl acetate copolymers.

16. The structure of claim 10, wherein the substrate is a rigid signboard.

17. The structure of claim 10, wherein the substrate is comprised of a rigid, foamed material.

18. The structure of claim 10, wherein the clear, laminated protective layer is comprised of a material selected from the group consisting of poly(ethylene terephthalate), poly(vinyl chloride), and polycarbonate.
